(19) United States
(12) Patent Application Publication
(10) Pub. No.: US 2008/0095696 A1
(43) Pub. Date: Apr. 24, 2008

(54) Carbon black for functional rubber component

(76) Inventor: Yoshiaki Matsushima, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/974,463

(22) Filed: Oct. 12, 2007

(30) Foreign Application Priority Data
Oct. 20, 2006 (JP) 2006-285974

(51) Int. Cl. C09C 1/48

(52) U.S. Cl. 423/449.1

(57) ABSTRACT

The present invention provides carbon black for a functional rubber component which can provide rubber with an excellent set resistance and a high UHF vulcanization performance by high frequency induction heating. The carbon black has a nitrogen adsorption specific surface area (N₂SA) of 15 to 30 m²/g and a DBP absorption of 100 to 135 cm³/100 g, and satisfies the relationship of the following formulas (1) and (2).

460−10.5×N₂SA≧Dst (1)

2900≧H (2)

wherein N₂SA denotes the nitrogen adsorption specific surface area (m²/g), Dst denotes the modal diameter (nm) of a Stokes diameter distribution of carbon black aggregates, and H denotes the hydrogen content (μg/g) per 1 g of carbon black.

### BACKGROUND OF THE INVENTION

1. Field of the Invention

The present invention relates to carbon black for rubber suitable for a functional rubber component such as a weather strip and a glass run for automobiles.

2. Description of Related Art

A functional rubber component is required to have an excellent set resistance and extrudability (e.g. surface smoothness and dimensional stability). Therefore, soft carbon black such as SRF and GPF having a small specific surface area (i.e. large particle diameter) and an appropriately developed structure has been used for functional rubber components.

In recent years, it has been demanded to shorten the time of ultra high frequency (UHF) vulcanization in order to improve productivity. The UHF vulcanization utilizes heat generated by high-frequency-induced molecular vibration. The heat generated by high frequency waves increases the specific surface area (decreases the particle diameter) of carbon black.

Specifically, carbon black particles having a small specific surface area are effective in providing an excellent set resistance (i.e. small set resistance) to the functional rubber component, whereas carbon black particles having a large specific surface area are suitable for facilitating high frequency induction heating to improve the efficiency of UHF vulcanization.

It is generally difficult to provide an excellent set resistance as rubber properties and improve the efficiency of UHF vulcanization at the same time, since the requirements in terms of particle properties such as the specific surface area and the particle diameter contradict.

Research has been conducted to improve productivity by selecting and determining a combination of carbon black properties in the application of a functional rubber component to provide a low set resistance to compounded rubber, and increasing UHF vulcanization performance. Many proposals have been made.

For example, JP-A-02-011664 discloses soft carbon black having an iodine adsorption (IA) of 15 to 25 mg/g and a DBP absorption of 100 to 150 ml/100 g, wherein the modal value (Dst) of the Stokes diameter measured by the centrifugal sedimentation method (DCF method) satisfies the formula (1) below, and the tinting strength satisfies the formula (2) below.

Dst(nm)≧(DBP)−7.5(IA)+350 (1)

Tinting strength (%)≦(IA)+25 (2)

JP-A-11-302557 discloses soft system high structure carbon black suitable for a functional rubber component, wherein the CTAB specific surface area is 25 to 60, DBP≧0.6×CTAB+120, and ΔDst/Dst is 0.60 to 1.00, and wherein the following formulas (1) and (2) are satisfied.

Dst<(6000/CTAB+60) (1)

I<0.25, wherein I=CTAB×(ΔDst/Dst)/DBO (2)

JP-A-2001-049028 discloses carbon black for rubber for a functional component having a CTAB specific surface area of 20 to 40 m²/g, an electric resistivity of 0.3 Ω·cm or less when compressed under a pressure of 50 kg/cm², and a toluene discoloration transmittance (LT) of 95% or more.

JP-A-2002-030233 discloses carbon black for a functional rubber component having a nitrogen adsorption specific area (N₂SA) of 20 to 40 m²/g, a DBP absorption of 100 to 135 ml/100 g, and a toluene color transmittance (LT) of 85% or more, wherein the specific tinting strength (Tint) satisfies the formula below, as the carbon black which provides both an excellent set resistance and a high UHF vulcanization performance.

Tint≧1.4N₂SA+2

### SUMMARY OF THE INVENTION

In general, carbon black having a large particle diameter and a small specific surface area is effective for improving the set resistance of compounded rubber and maintaining the set resistance at low level, whereas carbon black having a small particle diameter and a large specific surface area is effective for facilitating high frequency induction heating. In order to meet such contradicting requirements regarding particle properties of the carbon black, the above proposals are made, for example.

However, measures for providing both the set resistance and the UHF vulcanization performance at a high level have been insufficient. Thus, further improvement has been required. The inventor has conducted research on carbon black properties which can provide both the set resistance and the UHF vulcanization performance at a high level. As a result, the inventor has confirmed that carbon black having a small specific surface area and a regular to high structure level can provide such properties, when the modal diameter of the Stokes diameter distribution of carbon black aggregates obtained by the centrifugal sedimentation method per unit of the nitrogen adsorption specific area is small, and the amount of hydrogen per 1 g of the carbon black is equal to or smaller than a specific value.

The present invention has been achieved in view of the above finding. An object of the present invention is to provide carbon black for a functional rubber component which can provide rubber with an excellent set resistance and an excellent UHF vulcanization performance due to high heat generation during high frequency induction heating.

In order to achieve the above object, carbon black for a functional rubber component according to the present invention has a nitrogen adsorption specific surface area (N₂SA) of 15 to 30 m²/g and a DBP absorption of 100 to 135 cm³/100 g, and satisfies the relationship of the following formulas (1) and (2),

460−10.5×N₂SA≧Dst (1)

2900≧H (2)

wherein N₂SA denotes the nitrogen adsorption specific surface area (m²/g), Dst denotes the modal diameter (nm) of the Stokes diameter distribution of carbon black aggregates, and H denotes the hydrogen content (μg/g) per 1 g of carbon black.

A rubber composition formed by compounding a rubber component with the carbon black according to the present invention allows the rubber to exhibit an excellent set resistance and a high UHF vulcanization performance in a well-balanced manner while ensuring excellent surface smoothness and dimensional stability (low die swell). Therefore, the carbon black according to the present invention is extremely useful as carbon black for various industrial functional rubber components to which UHF vulcanization is generally applied, such as a weather strip and a glass run for an automobile and a sponge material.

### BRIEF DESCRIPTION OF THE DRAWINGS

FIG. 1 shows a distribution curve representing the relationship between the elapsed time from the addition of a carbon black dispersion for Dst measurement and the absorbance of carbon black due to centrifugal sedimentation.

FIG. 2 shows a distribution curve representing the relationship between the Stokes diameter obtained by Dst measurement and the absorbance.

FIG. 3 is a side cross-sectional view exemplifying a cylindrical reaction furnace used for producing the carbon black for a functional rubber component according to the present invention.

FIG. 4 shows a scatter diagram representing the relationship between the compression set and the dielectric loss according to the examples, the comparative examples, and the reference examples.

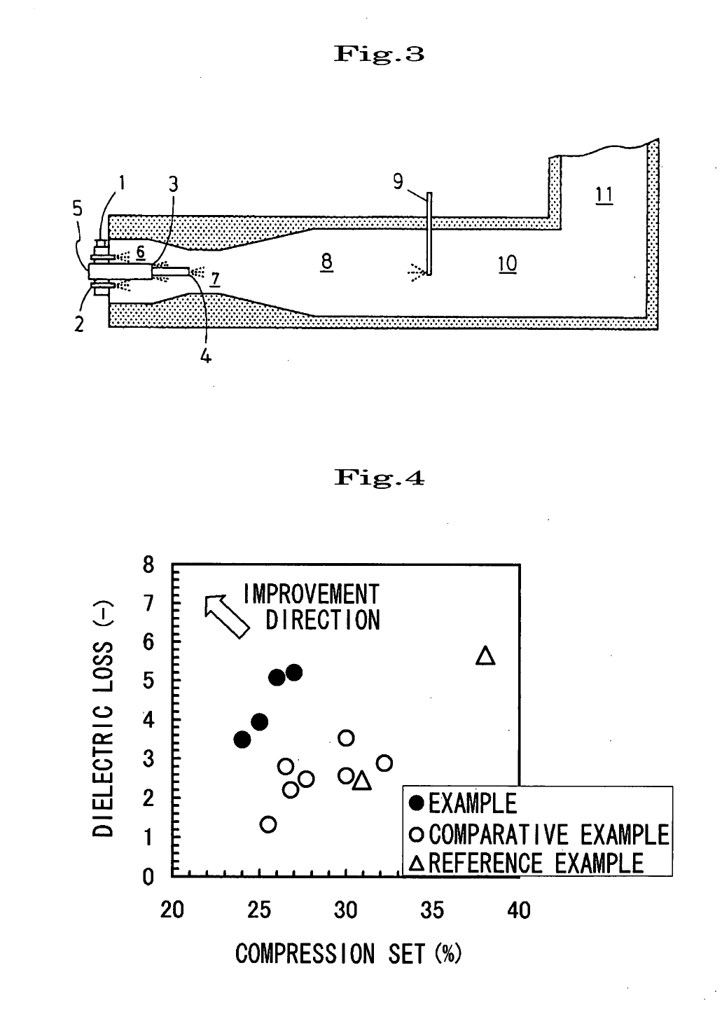

In FIG. 3, reference numeral 1 denotes a tangential direction air supply port, reference numeral 2 denotes a primary burner, reference numeral 3 denotes an external cylinder raw material burner, reference numeral 4 denotes an axial cylinder feedstock nozzle, reference numeral 5 denotes a feedstock spray nozzle, reference numeral 6 denotes a combustion chamber, reference numeral 7 denotes a small diameter section, reference numeral 8 denotes a large diameter reaction chamber, reference numeral 9 denotes a water-cooled quench, reference numeral 10 denotes a rapid cooling section, and reference numeral 11 denotes a flue.

### DETAILED DESCRIPTION OF THE INVENTION AND PREFERRED EMBODIMENT

A nitrogen adsorption specific surface area (N₂SA) of 15 to 30 m²/g and a DBP absorption of 100 to 135 cm³/100 g are prerequisite property requirements for the carbon black according to the present invention.

Specifically, the reinforcement effect and the UHF vulcanization performance of compounded rubber decrease when the nitrogen adsorption specific surface area (N₂SA) is smaller than 15 m²/g, whereas the set resistance inevitably decreases when the nitrogen adsorption specific surface area (N₂SA) is greater than 30 m²/g. The swelling rate of compounded rubber increases thereby decreasing the dimensional stability and deteriorating the surface (smoothness) when the DBP absorption is smaller than 100 cm³/100 g, whereas the viscosity at the time of rubber compounding increases thereby decreasing the kneadability when the DBP absorption is greater than 135 cm³/100 g.

In addition to the prerequisite property requirements described above, the carbon black for a functional rubber component according to the present invention is required to satisfy the relationship of the formulas (1) and (2).

Carbon black having properties which satisfy the formula (1), 460−10.5×N₂SA≧Dst, has a small modal diameter (Dst) of a Stokes diameter distribution of carbon black aggregates per unit specific surface area (N₂SA). The modal diameter Dst which corresponds to the level of the nitrogen adsorption specific surface area (N₂SA) is relatively smaller than that of traditional carbon black.

Carbon black having properties which satisfy the formula (2), 2900≧H, has a small amount of hydrogen per unit weight. Hydrogen generated by thermal decomposition of a hydrocarbon raw material remains on the surfaces of carbon black particles, particularly the end surfaces of a crystallite, due to the production process. Since the remaining hydrogen inhibits conductivity, the dielectric constant decreases whereby the UHF vulcanization performance decreases. A small amount of hydrogen which satisfies 2900≧H prevents the dielectric constant from decreasing to low level.

The requirements expressed by the formulas (1) and (2) act synergistically with the prerequisite properties (i.e. specified nitrogen adsorption specific surface area and DBP absorption) to confer a set resistance and a high level of UHF vulcanization performance to the compounded rubber.

The properties are measured by the following methods.

### (1) Nitrogen Adsorption Specific Surface Area (N₂SA)

JIS K6217-2 “Carbon black for rubber, fundamental properties—part 2: determination of specific surface area—nitrogen adsorption method, single-point method”

### (2) DBP Absorption

JIS K6217-4 “Carbon black for rubber, fundamental properties—part 4: determination of DBP absorption”

### (3) Hydrogen Amount H

Measurement device: Hydrogen analyzer EMGA-621 manufactured by Horiba, Ltd. Measurement condition: Extraction temperature of 1980° C., accumulation time of 70 seconds, carrier gas (argon gas) flow rate of 400 ml/min

### (4) Modal Diameter Dst of Stokes Diameter Distribution of Aggregates

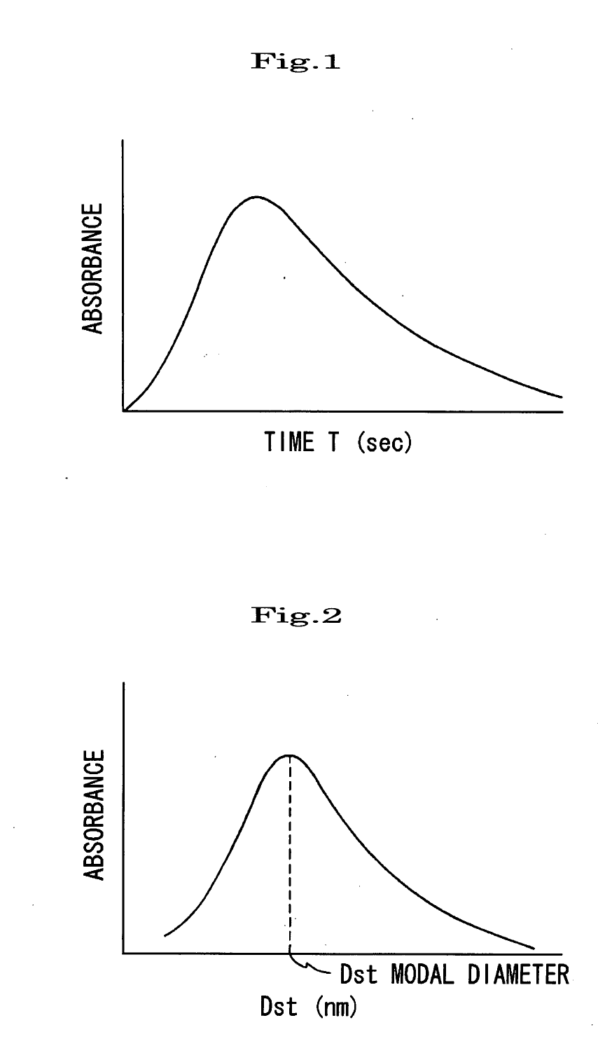

A sample of dried carbon black is mixed with a 20 vol % ethanol aqueous solution including a small amount of surfactant to prepare a dispersion having a carbon black concentration of 0.1 kg/m³. The carbon black is sufficiently dispersed by applying ultrasonic waves to prepare a sample. A disk centrifuge device (manufactured by Joyes Lobel, UK) is set at a rotational speed of 100 s⁻¹. After addition of 0.015 dm³ of a spin solution (2 wt % glycerine aqueous solution, 25° C.), 0.001 dm³ of a buffer solution (20 vol % ethanol aqueous solution, 25° C.) is injected. After the carbon black dispersion at 25° C. is added in an amount of 0.0005 dm³ by an injection syringe, the centrifugal sedimentation is started and a recorder is operated at the same time to create a distribution curve (horizontal axis: elapsed time from the addition of carbon dispersion by injection syringe, vertical axis: absorbance at a specific point changing with the progress of centrifugal sedimentation of carbon sample) shown in FIG. 1. The time T is read from the distribution curve and substituted in the following formula to calculate a corresponding Stokes diameter.

$$Dst ( nm ) = \sqrt{\frac{1.0498 \times {10}^{6} \cdot η}{{N}^{2} ( {ρ}_{CB} - {ρ}_{i} )} log \frac{{r}_{2}}{{r}_{1}}} \times \sqrt{\frac{1}{T}} \times {10}^{6}$$

In the above formula, η denotes the viscosity (0.935×10⁻³ Pa·s) of the spin solution, N denotes the disk rotational speed (100 s⁻¹), r₁ denotes the diameter (0.0456 m) at the carbon dispersion injection point, r₂ denotes the diameter (0.0482 m) up to the absorbance measurement point, PCB denotes the carbon density (kg/m³), and ρ₁ denotes the spin solution density (1.00178 kg/m³).

The modal value of the Stokes diameter according to the distribution curve (FIG. 2) thus obtained, which shows the relationship between the Stokes diameter and the absorbance, is determined as the Stokes modal diameter Dst (nm).

The method of producing the carbon black for a functional rubber component according to the present invention is not particularly limited. Note that feedstock should be supplied separately from the center and the outside, combustion and thermal decomposition should start at the same time, and the feedstock supplied from the outside should partially be thermally decomposed from an early stage. Note also that hydrogen can be effectively removed by performing the thermal decomposition for a long period of time (e.g. adjusting a long reaction residence time in a temperature zone of about 1200 to 800° C.).

Specifically, the carbon black is produced by mixing/burning an appropriate oxidizing agent including air or oxygen preheated to 400 to 500° C. and fuel oil in a large-diameter cylindrical reaction furnace having a drum-shaped squeezing section which can narrow or broaden to generate high-temperature combustion gas, and supplying atomized feedstock preheated to 150 to 200° C. to the high-temperature combustion gas to thermally decompose the feedstock.

For example, the carbon black is produced by a cylindrical reaction furnace shown in FIG. 3 which includes a tangential direction air supply port 1 at the end section, primary burners 2 attached in the axial direction of the furnace, a combustion chamber 6 including a feedstock spray nozzle 5 having a dual structure formed of an external cylinder raw material burner 3 which has a water-cooled coating and is reciprocable in the axial direction of the furnace and a telescopic axial cylinder feedstock nozzle 4 attached to the external cylinder raw material burner 3, a drum-shaped small diameter section 7 and a large diameter reaction chamber 8 provided coaxially, a rapid cooling section 10 including a water-cooled quench 9 at the downstream region, and a flue 11 leading in the vertical direction. The axial cylinder feedstock nozzle 4 is appropriately extended/compressed to adjust the feedstock introduction position.

The carbon black according to the present invention is compounded by an ordinary method with a rubber component along with necessary components such as a vulcanizing agent, a vulcanizing accelerator, a vulcanizing co-agent, an aging preventive, a softening agent, and a plasticizer. The compound is kneaded, and subjected to a vulcanization process to obtain a desired rubber composition. The rubber component may be natural rubber, styrene-butadiene rubber, polybutadiene rubber, isoprene rubber, chloroprene rubber, acrylonitrile-butadiene rubber, ethylene-propylene rubber, butyl rubber, other synthetic rubber of various types which can be reinforced by carbon black, or a blend of these rubbers. The amount of carbon black is set within a range of 20 to 200 parts by weight based on 100 parts by weight of the rubber component, and preferably 50 to 150 parts by weight.

### EXAMPLES

The present invention will be described below in detail by way of examples and comparative examples.

### Examples 1 to 4, Comparative Examples 1 to 7, and Reference Examples 1 and 2

The measurements of the reaction furnace shown in FIG. 3 were as follows.

### Combustion chamber 6: Inner diameter of 700 mm, length of 1200 mm

### Small diameter section 7 (drum shape): Inner diameter of 350 mm, length of 300 mm

### Large diameter reaction chamber 8: Inner diameter of 800 mm, length of 10000 mm

The feedstock spray nozzle 5 having a dual structure was attached to the end of the furnace along the central axis, and four primary burners 2 were provided coaxially around the feedstock spray nozzle 5. The position of the feedstock nozzle of the external cylinder raw material burner 3 of the feedstock spray nozzle 5 was adjusted to the starting position of the narrow section. The position of the axial cylinder feedstock nozzle 4 was adjusted to the starting position of the small diameter section.

Carbon blacks having different properties were produced by the cylindrical reaction furnace using fuel oil and feedstock having properties shown in Table 1. Conditions such as the total amount of air supplied, the amount of fuel oil supplied, the fuel oil combustion rate, the amount of feedstock supplied from the external cylinder, the amount of feedstock supplied from the axial cylinder, the spray pressure of feedstock, and the residence time (reaction time) in the furnace up to the quench were changed accordingly. The conditions for producing carbon black and the properties of the resulting carbon black are shown in Tables 2 and 3.

TABLE 1

| Properties | Fuel oil | Feedstock |
|---|---|---|
| Specific gravity (15/4° C.) | 1.027 | 1.107 |
| Toluene insoluble (%) | 0.01 | 0.05 |
| Correlation coefficient (BMCI) | 111 | 155 |
| Sulfur (%) | 0.09 | 0.39 |
| Initial boiling point (° C.) | 136 | 216 |
| Na⁺ (ppm) | 1.8 | 10.1 |
| K⁺ (ppm) | 0.7 | 0.4 |

TABLE 2

| | | Example | | | |
|---|---|---|---|---|---|
| | Conditions and properties/example | 1 | 2 | 3 | 4 |
| Conditions | Total amount of air supplied (Nm³/H) | 1000 | 1200 | 1400 | 1600 |
| for | Amount of fuel oil supplied (Kg/H) | 50 | 60 | 70 | 80 |
| production | Fuel oil combustion rate (%) | 200 | 200 | 200 | 200 |
| | Amount of feedstock supplied from external cylinder (Kg/H) | 50 | 50 | 50 | 50 |
| | Amount of feedstock supplied from axial cylinder (Kg/H) | 350 | 350 | 350 | 350 |
| | Spray pressure of feedstock (Kg/cm²) | 10 | 10 | 10 | 10 |
| | Reaction time (m · sec)*¹ | 1922 | 1602 | 1373 | 1202 |
| Carbon | N₂SA (m²/g) | 16 | 19 | 22 | 27 |
| black | DBP absorption (cm³/100 g) | 110 | 120 | 130 | 130 |
| properties | Dst (nm) | 280 | 221 | 215 | 160 |
| | Hydrogen content (μg) | 2700 | 2600 | 2600 | 2600 |
| | H (hydrogen content per gram) (μg/g) | 169 | 137 | 118 | 96 |
| | 460-10.5 × N₂SA (nm) | 292 | 261 | 229 | 177 |

Note)
*¹Residence time of combustion gas from introduction of feedstock to quench

TABLE 3

| | | Comparative Example | | | | | | |
|---|---|---|---|---|---|---|---|---|
| | Conditions and properties/example | 1 | 2 | 3 | 4 | 5 | 6 | 7 |
| Conditions for | Total amount of air supplied (Nm³/H) | 1000 | 1200 | 1400 | 1600 | 1000 | 1400 | 1800 |
| production | Amount of fuel oil supplied (Kg/H) | 50 | 60 | 70 | 80 | 49 | 65 | 80 |
| | Fuel oil combustion rate (%) | 200 | 200 | 200 | 200 | 200 | 210 | 220 |
| | Amount of feedstock supplied from external cylinder (Kg/H) | 0 | 0 | 0 | 0 | 33 | 59 | 56 |
| | Amount of feedstock supplied from axial cylinder (Kg/H) | 400 | 400 | 400 | 400 | 439 | 304 | 254 |
| | Spray pressure of feedstock (Kg/cm²) | 10 | 10 | 10 | 10 | 12 | 11 | 15 |
| | Reaction time (m · sec)*² | 1173 | 1282 | 1099 | 962 | 1539 | 1099 | 855 |
| Carbon black | N₂SA (m²/g) | 22 | 22 | 28 | 33 | 21 | 25 | 30 |
| properties | DBP absorption (cm³/100 g) | 105 | 115 | 125 | 125 | 104 | 122 | 112 |
| | Dst (nm) | 240 | 262 | 216 | 194 | 251 | 211 | 190 |
| | Hydrogen content (μg) | 3000 | 2900 | 3700 | 3100 | 3350 | 3150 | 3050 |
| | H (hydrogen content per gram) (μg/g) | 136 | 132 | 132 | 94 | 160 | 126 | 102 |
| | 460-10.5 × N₂SA (nm) | 229 | 229 | 166 | 114 | 240 | 198 | 145 |

Note)
*²Residence time of combustion gas from introduction of feedstock to quench

Table 4 shows properties of commercially-available carbon black (Reference Example 1: product similar to ASTM-N550, Reference Example 2: product similar to ASTM-N660).

TABLE 4

| | | Reference | |
|---|---|---|---|
| | | Example | |
| | Conditions and properties/example | 1 | 2 |
| Carbon | N₂SA (m²/g) | 43 | 27 |
| black | DBP absorption (cm³/100 g) | 115 | 90 |
| properties | Dst (nm) | 147 | 190 |
| | Hydrogen content (μg) | 3300 | 3200 |
| | H (hydrogen content per gram) (μg/g) | 77 | 119 |
| | 460-10.5 × N₂SA (nm) | 9 | 177 |

The samples of carbon black were compounded with EPDM rubber in a proportion shown in Table 5. The amounts of carbon black were varied to adjust the hardness (JIS, Hs) of compounded rubber to 70.

TABLE 5

| Component | Ratio (parts by weight) |
|---|---|
| EPDM | 100 |
| Carbon black | Varied |
| Paraffinic oil | 60 |
| Stearic acid | 1 |
| Zinc oxide | 5 |
| Vulcanizing accelerator*³ (PZ) | 1.5 |
| Vulcanizing accelerator (TMT) | 1.5 |
| Vulcanizing accelerator (M) | 0.5 |
| Sulfur | 1 |

Note)
*³Vulcanizing accelerator: Accel PZ, TMT, M manufactured by Kawaguchi Chemical Industry Co., LTD.

The compounded rubber was subjected to UHF vulcanization by induction heating at 160° C. for 15 minutes. The properties of the resulting rubber composition were measured. The results are shown in Table 6 (examples), Table 7 (comparative examples), and Table 8 (reference examples). Tests for measuring the heat generated during UHF vulcanization, the compression set as an index of the set resistance, and the die swell were conducted as follows. All other tests were conducted according to JIS K6301 “Physical testing methods for vulcanized rubber.”

### Heat Generated During UHF Vulcanization:

The dielectric constant (∈) and the loss coefficient (D) were measured under the conditions below using MQ-1601 manufactured by Meguro Electronics Corporation as a test piece of unvulcanized rubber. The heat generated during UHF vulcanization is evaluated using the product of the dielectric constant and the loss coefficient (∈×D: dielectric loss) as an index. A larger value indicates higher generated heat and shorter vulcanization time.

Test piece: Diameter of 45 mm, thickness of 2 mm

### Frequency: 20 MHz

### Temperature: Room temperature

### Compression Set:

The compression set was measured under a condition of 70° C.×70H according to JIS K6301 “Physical testing methods for vulcanized rubber.” A smaller value indicates a more preferable set resistance.

### Die Swell:

The die swell was measured under conditions in which the die diameter (D) is 1.51 mm, L/D=10, the temperature is 100° C., and the shear speed is 1000 sec⁻¹ using a Monsanto Processability Tester (manufactured by Monsanto Company). The die swell is shown by the swelling rate of the diameter of the extruded product to the die diameter. A smaller value indicates a higher dimensional stability, surface smoothness, and extrudability.

TABLE 6

| | | Example | | | |
|---|---|---|---|---|---|
| | | 1 | 2 | 3 | 4 |
| CB amount (phr) | | 145 | 140 | 140 | 125 |
| Rubber | Hardness (HS) (JIS A method) | 70 | 69 | 70 | 69 |
| properties | Tensile strength (TB) (Mpa) | 6.7 | 7.0 | 7.4 | 7.8 |
| | Compression set (Cs) (%) | 24.0 | 25.0 | 26.0 | 27.0 |
| | Dielectric constant (ε) (×10⁻¹² F/m) | 69.7 | 70.3 | 72.4 | 80.0 |
| | Loss coefficient (D) | 0.050 | 0.056 | 0.070 | 0.065 |
| | Dielectric loss (ε × D) | 3.49 | 3.94 | 5.07 | 5.20 |
| | Die swell (%) | 24.0 | 24.5 | 24.9 | 25.3 |
| | Mooney viscosity (ML1 + 4) (125° C.) | 27.0 | 28.3 | 29.4 | 29.3 |
| | Surface smoothness | Good | Good | Good | Good |

TABLE 7

| | | Comparative Example | | | | | | |
|---|---|---|---|---|---|---|---|---|
| | | 1 | 2 | 3 | 4 | 5 | 6 | 7 |
| CB amount (phr) | | 140 | 140 | 120 | 110 | 130 | 120 | 110 |
| Rubber | Hardness (HS) (JIS A method) | 69 | 70 | 71 | 72 | 71 | 70 | 70 |
| properties | Tensile strength (TB) (Mpa) | 7.2 | 7.5 | 7.7 | 7.9 | 8.2 | 10.6 | 12.8 |
| | Compression set (Cs) (%) | 25.5 | 26.5 | 30.0 | 32.2 | 26.8 | 27.7 | 30.0 |
| | Dielectric constant (ε) (×10⁻¹² F/m) | 52.8 | 70.0 | 65.8 | 70.5 | 54.9 | 58.9 | 60.8 |
| | Loss coefficient (D) | 0.025 | 0.040 | 0.039 | 0.041 | 0.040 | 0.042 | 0.058 |
| | Dielectric loss (ε × D) | 1.32 | 2.80 | 2.57 | 2.89 | 2.20 | 2.47 | 3.53 |
| | Die swell (%) | 25.4 | 25.3 | 25.7 | 26.7 | 23.1 | 22.7 | 23.5 |
| | Mooney viscosity (ML1 + 4) (125° C.) | 27.4 | 28.9 | 29.2 | 29.4 | 26.8 | 27.6 | 25.9 |
| | Surface smoothness | Good | Good | Average | Bad | Good | Good | Good |

TABLE 8

| | | Reference example | |
|---|---|---|---|
| | | 1 | 2 |
| CB amount (phr) | | 110 | 130 |
| Rubber | Hardness (HS) (JIS A method) | 73 | 70 |
| properties | Tensile strength (TB) (Mpa) | 9.5 | 8.1 |
| | Compression set (Cs) (%) | 38.0 | 30.9 |
| | Dielectric constant (ε) (×10⁻¹² F/m) | 75.6 | 60.0 |
| | Loss coefficient (D) | 0.075 | 0.041 |
| | Dielectric loss (ε × D) | 5.67 | 2.46 |
| | Die swell (%) | 25.5 | 26.3 |
| | Mooney viscosity (ML1 + 4) (125° C.) | 31.5 | 28.7 |
| | Surface smoothness | Average | Bad |

The relationship between the compression set as an index of the set resistance (i.e. resistance to a permanent set which occurs as a result of repeated stress) and the dielectric loss (∈×D) as an index of heat properties during UHF vulcanization is shown in FIG. 4.

The results show that the rubber compositions of the examples compounded with the carbon black having the required properties according to the present invention exhibit a higher dielectric loss relative to compression set, while maintaining higher smoothness and dimensional stability (lower die swell) compared to the rubber compositions of the comparative examples and the reference examples. Accordingly, the rubber compositions of the examples provide both the set resistance and a high UHF vulcanization performance.

What is claimed is:

1. Carbon black for a functional rubber component having a nitrogen adsorption specific surface area (N₂SA) of 15 to 30 m²/g and a DBP absorption of 100 to 135 cm³/100 g, and satisfying the relationship of the following formulas (1) and (2),
460−10.5×N₂SA≧Dst (1)
2900≧H (2)
wherein N₂SA denotes the nitrogen adsorption specific surface area (m²/g), Dst denotes a modal diameter (nm) of a Stokes diameter distribution of carbon black aggregates, and H denotes a hydrogen content (μg/g) per 1 g of the carbon black.
